(19) United States
(12) Patent Application Publication
(10) Pub. No.: US 2014/0279159 A1
(43) Pub. Date: Sep. 18, 2014

(54) PROGRESSIVE LOT BIDDING FOR ONLINE AUCTIONS

(71) Applicant: Auction.com, LLC, Irvine, CA (US)

(72) Inventor: Robert Friedman, Laguna Hills, CA (US)

(73) Assignee: Auction.com, LLC, Irvine, CA (US)

(21) Appl. No.: 14/214,643

(22) Filed: Mar. 14, 2014

Related U.S. Application Data
(60) Provisional application No. 61/799,685, filed on Mar. 15, 2013.

(51) Int. Cl. G06Q 30/08

(52) U.S. Cl. CPC G06Q 30/08
USPC 705/26.3

(57) ABSTRACT

A bidding process is initiated for a lot of multiple items. Upon the bidding process being complete, a highest bid is determined for the lot of multiple items. A highest bidder is prompted to select a number of items from the lot of multiple items for transaction based on the highest bid. A number of remaining items are determined after the selected number of items are removed from the lot. For a duration of time, one or more other auction participants are prompted to select any one or more of the remaining items for transaction based on the highest bid. After the duration, a second bidding process is initiated for a lot of multiple remaining items that were not selected for transaction by the one or more other participants.

### RELATED APPLICATION

This application claims the benefit of priority to Provisional Application No. 61/799,685 filed on Mar. 15, 2013, entitled PROGRESSIVE LOT BIDDING FOR ONLINE AUCTIONS; the aforementioned priority application being hereby incorporated by references in its entirety.

### TECHNICAL FIELD

Examples described herein relate to online auctions, and more specifically, to a system and method for providing progressive lot bidding for online markets.

### BACKGROUND

Numerous online auction forums exist that enable consumers and sellers to transact for various kinds of items, such as collectibles, electronics and other goods or services.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 illustrates a system for implementing an auction forum in which auctions for lots of multiple items are auctioned in accordance with a set of progressive lot bidding rules;

FIG. 2 illustrates a method for conducting an auction in accordance with progressive lot bidding rules;

FIG. 3 illustrates a method for determining a reserve price in context of an auction in which lot bidding rules are in place;

FIG. 4 illustrates an example interface for an auction form in which progressive lot bidding rules are implemented; and

FIG. 5 is a block diagram that illustrates a computer system upon which embodiments described herein may be implemented.

### DETAILED DESCRIPTION

Examples described herein provide a system or method for conducting an online auction using progressive lot bidding rules. Among other benefits, examples provided herein enable an auction sale for a lot of items to achieve a higher overall price per-item as compared to conventional approaches for lot auctions. In particular, examples recognize that bidder uncertainty can increase bidding activity and interest. The increased activity can in turn yield higher sale prices for auctions in which multiple items are auctioned in lots.

According to examples, a bidding process is initiated for a lot of multiple items. Upon the bidding process being complete, a highest bid is determined for the lot of multiple items. A participant that submits the highest bid is enabled or prompted to select a number of items from the lot of multiple items for transaction based on the highest bid. A number of remaining items are determined after the selected number of items are removed from the lot. For a duration of time, one or more other participants are enabled to select any one or more of the remaining items for transaction based on the highest bid. After the duration, a second bidding process is initiated for a lot of multiple remaining items that were not selected for transaction by the one or more other participants.

One or more examples described herein provide that methods, techniques, and actions performed by a computing device are performed programmatically, or as a computer-implemented method. Programmatically means through the use of code, or computer-executable instructions. A programmatically performed step may or may not be automatic.

One or more examples described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing features can be carried and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

FIG. 1 illustrates a system for implementing an auction forum in which auctions for lots of multiple items are auctioned in accordance with a set of progressive lot bidding rules. A system 100 such as shown by an example of FIG. 1 can be implemented in connection with an online auction service for any type of commercial item, such as, for example, real property items, (e.g., homes, real-estate notes, commercial property), motor vehicles (e.g., automobiles, motorcycles, boats), consumer electronics, collectibles, or clothing. According to some aspects, system 100 can be implemented in connection with auctions which offer items for sale in groups. For example, items that are identical, or similar in type, brand, and/or condition can sometimes be sold more easily in lots.

In an example of FIG. 1, system 100 includes functionality that can be implemented by processes, logical components and/or modules. In an example of FIG. 1, system 100 includes an offer or bidder interface 110, transaction logic 120, an auction manager 130, and an auction database 140. The auction database 140 can retain records that identify items that are to be auctioned, and/or items which are undergoing or have completed an auction. In some implementations, the auction database 140 is coupled to a seller interface 144. The seller interface 144 enables individual sellers to create records that identify an item for auction. The seller interface 144 can enable sellers to specify information 143 that identifies the item being auctioned, the terms of sale, and other parameter such as a reserve price (which can be hidden from prospective bidders). The database 140 can retain records 141 of auctions in various states, including pre-auction, in-auction (auction initiated) and post-auction (auction completed).

With regard to lot bidding, the reserve price can reflect a single item price, or a price for the entire lot. When progressive lot bidding rules are implemented, the seller can also designate an amount, formula or parameter for setting the reserve price at either a first round or at a following round.

The bidder interface 110 includes functionality for enabling bidders to view and participate in an in-progress auction. Accordingly, the bidder interface 110 can include functionality for enabling a bidder to specify a bid, and to monitor in real-time the current value of an item being auctioned. The bidder interface 110 can be provided as, for example, a webpage that includes functional elements for enabling the users to provide input (e.g., bids) and to view real-time updates for the in auction while it is in progress. In variations, the bidder interface 110 can be provided as application content, such as through a display or panel of a network-enabled application.

The auction manager 130 provides the framework and implements a set of auction rules 133 by which the individual auctions are conducted. The auction manager 130 interfaces with the database 140 in order to retrieve auction records 145. Each auction record can identify one or multiple items for auction. If multiple auctions are identified for an auction, progressive lot bidding rules 135 may be implemented as to how the auction is conducted. Other auction rules 133 that can be implemented include extension periods, where an auction for an item or lot of items is extended if a bid is received at a designated duration (e.g., one minute) before the auction is completed. In addition to identifying one or more items, each auction record can identify the reserve price (or optionally reserve prices for lot bidding) and provide descriptive information such as images or text for the item(s), as well as other information.

The transaction logic 120 can implement operations for progressing the auction towards completion. As shown by an example of FIG. 1, multiple instances of transaction logic 120 can be implemented at a given time in order to conduct an auction and to progress the auction towards completion. One or more of the auctions can be for a lot of multiple items. For such auctions, the auction manager 130 implements progressive lot bidding rules.

The transaction logic 120 can be coupled to database 140 to receive information from records 141 that are to be auctioned. The transaction logic 120 can include functionality to (i) initiate an auction process in accordance with the auction rules 133, (ii) advance the auction towards completion, and (iii) end or complete the auction when certain conditions are satisfied (e.g., after completion of time and/or satisfaction of completion rules). In addition to receiving and processing bids 111, the transaction logic 120 provides an auction update 113 to the bidders that are viewing or participating in a particular auction. The auction update 113 can include information such as a current price for the item being auctioned, an amount of time remaining in the auction, and/or comments from other users.

For auctions in which multiple items are being sold as a lot, progressive lot bidding rules 135 may be implemented. As described with an example of FIG. 2, with progressive lot bidding rules 135, the transaction logic 120 may (i) prompt the participant with the winning bid to transact for only a portion of the lot (e.g., one, some or all), (ii) re-start the auction process for a remainder portion of the lot, and (iii) repeat the lot bidding process as needed. In one example, the progressive lot bidding rules 135 may provide for the transaction logic 120 to communicate a notification through the bidder interface 110 that enables and/or prompts participants other than the winning bidder to purchase one, some or all of the items in the lot at a given price. Examples for how the lot bidding rules may be implemented are described with FIG. 2.

Other information that can be updated by the transaction logic 120 and published through the bidder interface 110 including identifiers for active bidders, recent bid amounts, current bid increment (which optionally can change based on dynamic bid increment adjustments), comments from other users, and information from other auctions that may be in various states (e.g., pre-auction versus in-progress). The auction update 113 can be published through the bidder interface 110 to the population of users.

The timer 124 maintains the time remaining before the auction completes. As described with some examples, the timer 124 can be reset, or adjusted while the auction is in progress. As described below, the timer 124 can be managed by the auction manager 130. The timer 124 can be configured to respond to the occurrence of certain events, including events detected with individual auctions, or events detected with banded or linked auctions 145. When progressive lot bidding rules 135 are in effect, the timer 124 can further be initiated after an initial auction process is complete in order to provide a duration during which other participants can purchase remaining items from the lot at a designated price (e.g., price of highest bid).

The auction rules 133 can also include completion rules, which specify rules or conditions that affect the timer 124 maintained by each auction. In this way, the completion rules can specify when a particular auction is to be extended based on the occurrence of a designated event. In one example, completion rules 135 cause corresponding transaction logic 120 to extend an auction in the event an incoming bid is received in a given timeframe. For example, the completion rules 135 may specify that an auction will end at a given time, unless a bid is received in the last minute (or other duration), in which case the auction is extended.

Methodology

FIG. 2 illustrates a method for conducting an auction in accordance with progressive lot bidding rules. FIG. 3 illustrates a method for determining a reserve price in context of an auction in which lot bidding rules are in place. Examples such as described with FIG. 2 and FIG. 3 may be implemented using, for example, a system such as described with FIG. 1. Accordingly, reference may be made to elements of FIG. 1 for purpose of illustrating suitable components or elements for performing a step or sub-step being described.

With reference to FIG. 2, a first bidding process is initiated for a lot of items (210). The bidding process can be conducted through an online forum, such as hosted at a website and conducted through a server of the auction forum. Bidders or participants of the auction forum can use, for example, web-browsers or web-based applications in order to access the auction forum and the particular online auction in which progressive lot bidding rules are in place. Auction participants can submit bids 111 and view auction updates 113 via the offer interface 110. Over the course of the first bidding process, transaction logic 120 can process each bid and update the auction to reflect a current bid for the lot. Furthermore, the transaction logic 120 can include functionality to (i) initiate an auction process in accordance with the auction rules 133, (ii) advance the auction towards completion, and (iii) end or complete the auction when certain conditions are satisfied.

In some implementations, the items in the lot may be substantially homogenous, so that each item can be considered essentially the same as the other items. However, variations can be implemented in which items in the lot are different but are of the same category or subcategory. For example, the lot items can correspond to collectibles of a particular kind which have variation in year or vintage, condition, or which may be distinguishable on an individual basis.

Once the first bidding process is complete (220), the highest bidder is determined. The auction manager 130 can identify the completion of the lot auction and in response, implement progressive lot bidding rules. As such, the highest bidder is provided an opportunity to make a quantity selection from the lot. Based on input from the highest bidder, the quantity selection is determined for the transaction with the highest bidder (230). The highest bidder can, for example, select one, some or all of the items in the lot. The auction manager 130 can initiate a computer implemented process that provides the auction forum can prompt or otherwise signal to the highest bidder to select the quantity. For example, a computer system such as described with FIG. 5 can be operated to provide a web-resource for the seller which prompts the seller to enter a quantity from the lot. As described with various examples, some variations provide that restrictions can be placed on the seller in connection with the quantity that the seller can select that when that quantity is less than the entire lot. Additionally, the computer-implemented process can be responsive to the quantity designation of the highest bidder. By default, the highest bidder can elect to take the entire lot by not responding. The price the highest bidder pays for individual items in the lot may be based on the highest bid. For example, the highest bid can be provided for the entire lot, but separately divided per-item in the lot in order to determine price per-item. The price per-item can then be applied to each item that the seller takes when the seller takes less than the whole lot.

In variations, the price per-item may differ from the price the seller pays for the entire lot. For example, the buyer may have to pay a small penalty based on the portion of the lot that the seller decides to take. The penalty can be determined on a per-item basis, or based on some other metric (e.g., flat charge). In variations, rules implemented by the auction manager 130 can regulate just how many items from the lot the bidder can select. For example, in one implementation, the highest bidder can take one or all, but not some. In another variation, the highest bidder can take more than half and up to all, but not less than half. Numerous such variations are possible as to the quantity selection that can be made.

Once the number of items in the lot are transacted to the highest bidder, the auction manager 130 makes a determination as to whether any items are remaining in the lot (232). For example, the auction manager 130 can initiate a computer process running as part of the auction forum that can calculate the number of items that are left, either after the quantity selection is made by the seller, or after a time out occurs when no affirmative selection is made (e.g., when the seller implicitly accepts the entire lot). If no items are remaining in the lot (i.e., the highest bidder took the whole lot), the auction is deemed to end (234). The end of the auction can be published on, for example, a web page.

If items are remaining in the lot (i.e., the highest bidder took fewer than all of the items in the lot), then the auction manager 130 can implement a follow-on process for transacting the remaining items for other bidders. In one example, any bidder is initially provided an opportunity to purchase as many remaining items in the lot as they wish for the price provided by the highest bidder. For example, the computer process implemented by the auction manager 130 can communicate an auction forum communication that identifies a number of remaining items after the highest bidder selects the desired quantity (240).

In one implementation, the per-item price may be displayed over the offer interface 110, enabling any prospective bidder to pick up one, some or all of the remaining items at the highest bid, or some price based off of the highest bid (e.g., per-item price reduced by small percentage) (242). For example, a computer process implemented by the auction manager 130 can calculate the per-item price based on the winning bid. In variations, the per-item price as determined from the highest bid can be reduced by some predetermined percentage or variable when offering the remaining items of the lot. The opportunity for non-winning bidders to purchase items from the lot at a given price may be set to a timer that extends for a predetermined duration.

During the duration, selections may be received from bidders who elect to take remaining items at the price per-item that is based off the highest bid (250). For example, the auction manager 130 can initiate a computer process that initiates a timer and provides an input interface on the site for which prospective bidders can agree to take a quantity of the remaining items. Once the duration is complete, the quantity of remaining items that still remains is determined. A determination is made as to whether any remaining items are left (252). If no items are left in the lot, the auction ends at (234). Elsewise, a second bidding process is initiated for the number of items remaining in the lot (210). As such, the auction manager 130 can recognize the remaining items and implement the progressive lot bidding rules 135 to initiate a second bidding process. Accordingly, a new auction for the lot of remaining items is initiated in which the remaining auction participants can interact with the auction via the offer interface 110, in which bids 111 are processed by transaction logic 120, which communicates the auction updates 113 back the auction participants.

By way of example, if there are 10 items in the lot, and the winning bidder elects to take five items, the bidding process ends with five remaining items. Then, for a duration of time (e.g., 5 min.), losing bidders are notified that they can have one or more of the remaining items at either the price per-item of the highest bid, or some alternative (e.g., reduced) price based off the highest bid. If items still remain after the duration of time, the subsequent bidding process is initiated again at (210).

Among other benefits, examples described herein recognize that an element of uncertainty amongst bidders in an auction can encourage competitive bidding, and maximize the sale price of a lot of items. In examples such as described with FIG. 2, uncertainty can be introduced in that the highest bidder may or may not leave some items behind, and interested bidders can opt to wait and see how many items remain after the highest bidder makes the first selection. As the highest bidder does not need to take the entire lot, the highest bidder may be encouraged to bid more, given that the total price he will pay for a desired number of items is less than the price for the whole lot. These and other scenarios introduce uncertainty and bidding strategy, which can promote bidding interest and activity.

With reference to FIG. 3, a reserve price input is received from a seller of a lot of multiple items (310). For example, a computer process running as part of the online auction forum can generate a seller interface 144 for enabling the seller to enter amounts corresponding to a reserve price. The reserve price input can reference a specific price, a price tier, a formula, or multiple reserve prices based on the number of bidding processes are initiated and completed for selling the lot of items. Among other benefits, examples described herein recognize that a seller has an opportunity to set multiple reserve prices when implementing a progressive lot bidding auction. In one implementation, the seller can specify multiple tiers of reserve prices before the auction starts, with each tier corresponding to a round of the bidding process. As an alternative example, the seller can specify the reserve price separately on a round by round basis. In still another variation, the reserve price may automatically or by default be set in each round based on a predetermined formula that incorporates the initial reserve price (e.g., standard percentage from the original reserve price).

When progressive lot bidding rules are implemented for a lot of items, the first bidding process is initiated for the lot (320). In the implemented first bidding process, a first reserve price is determined based on the reserve price input (322).

The auction may complete with the highest bidder (330). The highest bidder may be required to exceed a reserve price, and the reserve price can be determined based on a per-item basis. Alternatively, whether the auction exceeds the reserve price can be determined programmatically based on whether the price selected for the quantity selected by the highest bidder exceeds the reserve price as proportion for the partial quantity selection of the highest bidder.

Optionally, after the first bidding process is complete, other bidders are given the opportunity to purchase the remaining items in the lot at a price that is based on the highest bid during the first bidding process. If remaining items are present from the lot after the first bidding process is complete, a second bidding process can be initiated for those remaining items (340). When the second bidding process is complete, the highest bidder may win an opportunity to take some or all of the remaining items if the highest bid exceeds the second reserve price (342). As mentioned, the second reserve price may be the same as the first reserve price, or the second reserve price may be different than the first reserve price. For example, the second reserve price may be less than the first reserve price.

With reference to example such as provided by FIG. 1 through FIG. 3, numerous variations are possible. For example, the first bidding process may be implemented by the auction manager 130 in accordance with the first set of auction rules 133, and the second bidding process may be implemented in accordance with the second set of auction rules 135. As a specific example, the first bidding process and the second bidding process may be conducted in accordance with different auction rules or styles. As a specific example, the winner of the second bidding process may be required to take all of the remaining items of a lot, rather than be selected as to the number taken. Such a change in the rule may, for example, provide additional motivation to bidders to provide the highest bid for the first bidding process.

Example Interface

FIG. 4 illustrates an example interface for an auction form in which progressive lot bidding rules are implemented. In an example of FIG. 4, an auction forum may be implemented through a website, and displayed to individual bidders through a webpage. In variations, the auction form can be provided through a web-based application that displays auction content provided from the network source.

In the example provided, the first bidding process may be assumed to have completed, and the winning bidder may have elected to take a quantity from the lot the corresponds a portion (e.g., 50%). The number of items from the lot that the winning bidder took may be communicated on the page for other perspective bidders. A timer 410 may be initiated for the remaining bidders, as well as information indicating the number of items that will be re-auctioned in a second bidding process. A communication can also be displayed on the page 400 that communicates the price per item that perspective bidders can pay to avoid having to purchase the remaining items from the lot in a follow-on bidding process.

Computer System

FIG. 5 is a block diagram that illustrates a computer system upon which examples described herein may be implemented. For example, in the context of FIG. 1, system 100 may be implemented using one or more servers such as described by FIG. 5. Additionally, a method such as described with FIG. 2 and FIG. 3 may be implemented using a computer system such as described with FIG. 5. By way of example, a computer system such as described with FIG. 5 can be implemented as part of a server process in which an online auction forum is conducted, and in which progressive lot bidding rules are in place for select auctions in which lots of multiple items are offered.

In an example, computer system 500 includes processor 504, memory 506 (including non-transitory memory), storage device 510, and communication interface 518. Computer system 500 includes at least one processor 504 for processing information. Computer system 500 also includes the main memory 506, such as a random access memory (RAM) or other dynamic storage device, for storing information and instructions to be executed by processor 504. Main memory 506 also may be used for storing temporary variables or other intermediate information during execution of instructions to be executed by processor 504. Computer system 500 may also include a read only memory (ROM) or other static storage device for storing static information and instructions for processor 504. The storage device 510, such as a magnetic disk or optical disk, is provided for storing information and instructions. The communication interface 518 may enable the computer system 500 to communicate with one or more networks through use of the network link 520 (wireless or wireline). The communication interface 518 may communicate with bidders and auction participants using, for example, the Internet.

Examples described herein are related to the use of computer system 500 for implementing the techniques described herein. According to one variation, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In variations, hard-wired circuitry may be used in place of or in combination with software instructions to implement variations described herein. Thus, examples described are not limited to any specific combination of hardware circuitry and software.

Although illustrative examples have been described in detail herein with reference to the accompanying drawings, variations to specific variations and details are encompassed by this disclosure. It is intended that the scope of examples described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computer-implemented method for conducting an online auction, the method implemented by one or more processors and comprising:
initiating a first auction for a lot of multiple items;
upon completion of the auction, determining a highest bid corresponding to a highest bidder for the lot of multiple items;
prompting the highest bidder to individually select one or more of the multiple items in the lot for transaction based on the highest bid;
removing the selected items from the lot, resulting in a lot of remaining items;
in response to removing the selected items, prompting, for a duration of time, auction participants to select one or more of the remaining items for transaction based on the highest bid;
removing the selected one or more of the remaining items from the lot of remaining items, resulting in a final lot of items;
after the duration of time, initiating a second auction for the final lot of items.

2. The computer-implemented method of claim 1, further comprising communicating to the auction participants, over a network, a price for each item in the lot of remaining items.

3. The computer-implemented method of claim 2, wherein the auction is conducted at a website, and wherein communicating to the auction participants includes publishing the price on a web page hosted at the website.

4. The computer-implemented method of claim 3, further comprising publishing a timer that displays the duration of time.

5. The computer-implemented method of claim 1, further comprising setting a first reserve price for at least the first auction, wherein prompting the highest bidder to individually select one or more of the multiple items in the lot is performed when the highest bid exceeds the first reserve price.

6. The computer-implemented method of claim 1, further comprising setting a second reserve price for the second auction.

7. The computer-implemented method of claim 1, wherein prompting the auction participants to select one or more of the remaining items for transaction includes listing a price-per item that is less than a price-per item of the highest bid.

8. The computer-implemented method of claim 1, wherein prompting the highest bidder to individually select one or more of the multiple items includes programmatically determining a price-per item selected that is proportionate to the highest bid.

9. The computer-implemented method of claim 1, wherein prompting the highest bidder to individually select one or more of the multiple items includes programmatically determining a price-per item selected that is higher as compared to a proportionate price-per item as determined from the highest bid.

10. A computer system comprising:
one or more processors;
a network interface; and
a memory resource storing instructions defining a set of auction rules, wherein the instructions, when executed by the one or more processors, cause the one or more processors to:
initiate a first auction for a lot of multiple items;
upon completion of the auction, determine a highest bid corresponding to a highest bidder for the lot of multiple items;
prompt the highest bidder to individually select one or more of the multiple items in the lot for transaction based on the highest bid;
remove the selected items from the lot, resulting in a lot of remaining items;
in response to removing the selected items, prompt, for a duration of time, auction participants to select one or more of the remaining items for transaction based on the highest bid;
remove the selected one or more of the remaining items from the lot of remaining items, resulting in a final lot of items; and
after the duration of time, initiate a second auction for the final lot of items.

11. The system of claim 10, wherein the instructions, when executed by the one or more processors, further cause the one or more processors to communicate to the auction participants, via the network interface, a price for each item in the lot of remaining items.

12. The system of claim 11, wherein the auction is conducted at a website, and wherein communicating to the auction participants includes publishing the price on a web page hosted at the website.

13. The system of claim 12, wherein the instructions, when executed by the one or more processors, further cause the one or more processors to publish a timer that displays the duration of time.

14. The system of claim 10, wherein the instructions, when executed by the one or more processors, further cause the one or more processors to set a first reserve price for at least the first auction, wherein prompting the highest bidder to individually select one or more of the multiple items in the lot is performed when the highest bid exceeds the first reserve price.

15. The system of claim 10, wherein the instructions, when executed by the one or more processors, further cause the one or more processors to set a second reserve price for the second auction.

16. The system of claim 10, wherein prompting the auction participants to select one or more of the remaining items for transaction includes listing a price-per item that is less than a price-per item of the highest bid.

17. The system of claim 10, wherein prompting the highest bidder to individually select one or more of the multiple items includes programmatically determining a price-per item selected that is proportionate to the highest bid.

18. The system of claim 10, wherein prompting the highest bidder to individually select one or more of the multiple items includes programmatically determining a price-per item selected that is higher as compared to a proportionate price-per item as determined from the highest bid.

19. A non-transitory computer-readable medium storing instructions for conducting an auction forum that, when executed by one or more processors, cause the one or more processors to:
initiate a first auction for a lot of multiple items;
upon completion of the auction, determine a highest bid corresponding to a highest bidder for the lot of multiple items;
prompt the highest bidder to individually select one or more of the multiple items in the lot for transaction based on the highest bid;
remove the selected items from the lot, resulting in a lot of remaining items;
in response to removing the selected items, prompt, for a duration of time, auction participants to select one or more of the remaining items for transaction based on the highest bid;
remove the selected one or more of the remaining items from the lot of remaining items, resulting in a final lot of items; and
after the duration of time, initiate a second auction for the final lot of items.

20. The non-transitory computer -readable medium of claim 19, wherein the instructions, when executed by the one or more processors, further cause the one or more processors to communicate to the auction participants, via the network interface, a price for each item in the lot of remaining items.
